(19) United States
(12) Patent Application Publication
(10) Pub. No.: US 2026/0349196 A1
(43) Pub. Date: Nov. 5, 2026

(54) OPTICAL ENGINE PACKAGING STRUCTURE BASED ON GRATING COUPLING

(71) Applicant: SHUNYUN TECHNOLOGY (ZHONGSHAN) Limited, Zhongshan (CN)

(72) Inventors: Guangsheng He, Zhongshan (CN); TeFu Tseng, Zhongshan (CN); Jie Huang, Zhongshan (CN); Mark Ming Seng Tieu, Zhongshan (CN); Quan Jiang, Zhongshan (CN)

(21) Appl. No.: 19/411,178

(22) Filed: Dec. 6, 2025

(30) Foreign Application Priority Data
Apr. 30, 2025 (CN) 202510561941.0

(51) Int. Cl. G02B 6/42

(52) U.S. Cl. CPC G02B 6/4242; G02B 6/4206; G02B 6/4243; G02B 6/4292

(57) ABSTRACT

Provided is an optical engine packaging structure based on grating coupling. The structure includes a substrate, silicon photonics chip, fiber array unit, and top cover. The silicon photonics chip is disposed on the substrate and provided with a first coupling portion and positioning seat; the positioning seat is provided with an optical through hole and a first alignment structure; the fiber array unit includes a fiber array and a fixing structure provided with a second coupling portion; the top cover is disposed on the substrate and provided with an insertion hole; the fixing structure is detachably disposed in the insertion hole and provided with a second alignment structure in a positioning fit with the first alignment structure; the top cover is movably provided with a pressing member; and the second coupling portion is in vertical alignment with the first coupling portion.

### CROSS REFERENCE TO RELATED APPLICATIONS

The present application claims the benefit of Chinese Patent Application No. 202510561941.0 filed on Apr. 30, 2025, the contents of which are incorporated herein by reference in their entirety.

### Technical Field

The present disclosure relates to the technical field of optical engines, and in particular to an optical engine packaging structure based on grating coupling.

### BACKGROUND

With the development of large-scale data centers and artificial intelligence (AI) compute clusters, co-packaged optics (CPO) plays a significant role in improving the data transmission rate. As a core component of the CPO, a silicon photonics chip is primarily used for converting optical and electrical signals, and for transmitting the optical signal via coupling to a fiber array.

For example, the Chinese Utility Model Patent No. CN 207181754 U granted on Apr. 3, 2018 discloses a parallel fiber-optic transceiver module, including a fiber array, a fiber substrate, and a fiber cover. The fiber substrate and the fiber cover constitute a 90-degree corner assembly, turning pigtails of the fiber array by 90 degrees. The fiber array includes a fiber positioning base, a cover plate, and a plurality of optical fibers. A plurality of high-precision fiber positioning grooves are formed in a top surface of the fiber positioning base. The optical fibers are embedded into the fiber positioning grooves, pressed tightly by the cover plate, and then bonded and fixed with glue, such that end faces of the optical fibers are accurately positioned and arranged into the fiber array. A square groove is formed in a bottom surface of the fiber positioning base. A top of the fiber substrate is provided with an arc-shaped surface with a 90-degree corner. The optical fibers are tightly attached to the arc-shaped surface. A small square boss is disposed at a bottom of the fiber substrate.

The parallel fiber-optic transceiver module in the prior art realizes 90-degree corner arrangement of the optical fibers in combination with the fiber substrate and the fiber cover. However, the parallel fiber-optic transceiver module is usually fixedly disposed on the silicon photonics chip. This cannot ensure coupling precision between the end faces of the optical fibers and waveguides of the silicon photonics chip, compromising a tradeoff between the coupling precision and the flexible detachment of the fiber array.

### SUMMARY

A technical problem to be solved by the present disclosure is that since an existing fiber-optic transceiver module is fixedly disposed on a silicon photonics chip, coupling precision between end faces of optical fibers and waveguides of the silicon photonics chip cannot be ensured easily to compromise a tradeoff between the coupling precision and flexible detachment of a fiber array.

To solve the above technical problem, the present disclosure provides technical solutions for an optical engine packaging structure based on grating coupling.

An optical engine packaging structure based on grating coupling includes a substrate, a silicon photonics chip, a fiber array unit, and a top cover, where the silicon photonics chip is disposed at a top side of the substrate; and the substrate is electrically connected to the silicon photonics chip;

a top side of the silicon photonics chip is provided with a first coupling portion and a positioning seat; the positioning seat is provided with an optical through hole that vertically penetrates through the positioning seat; and the optical through hole corresponds to the first coupling portion;

the fiber array unit includes a fiber array and a fixing structure; the fixing structure is fixedly connected to the fiber array; a bottom side of the fixing structure is provided with a second coupling portion; and the second coupling portion optically communicates with the fiber array;

the top cover is disposed at the top side of the substrate; the top cover is provided with an insertion hole corresponding to the positioning seat; and the fixing structure is detachably disposed in the insertion hole;

the top cover is further movably provided with a pressing member; the pressing member has a locked state and an unlocked state; and in the locked state, the pressing member is in a pressing fit with the fixing structure along an axial direction of the optical through hole; and

a top side of the positioning seat is provided with a first alignment structure; the bottom side of the fixing structure is provided with a second alignment structure; the second alignment structure is in a positioning fit with the first alignment structure within a radial plane of the optical through hole; and the second coupling portion is in vertical alignment with the first coupling portion.

Further, the first alignment structure is a protrusion structure, and the second alignment structure is a groove structure; or the first alignment structure is a groove structure, and the second alignment structure is a protrusion structure.

Further, the first alignment structure includes transverse ribs and longitudinal ribs; the transverse ribs extend along a direction parallel to a width direction of the fiber array; and the longitudinal ribs are respectively perpendicular to the transverse ribs within the radial plane of the optical through hole;

the second alignment structure includes transverse grooves and longitudinal grooves; the transverse grooves extend along the direction parallel to the width direction of the fiber array; and the longitudinal grooves are respectively perpendicular to the transverse grooves within the radial plane of the optical through hole; and

the transverse ribs are respectively in a concave-convex fit with the transverse grooves; and the longitudinal ribs are respectively in a concave-convex fit with the longitudinal grooves.

Further, the optical through hole has first long sides and first short sides; the first long sides extend along the width direction of the fiber array; the first short sides are respectively perpendicular to the first long sides; there are two transverse ribs and two longitudinal ribs; the two transverse ribs are respectively disposed at outer sides of the first long sides of the optical through hole; and the two longitudinal ribs are respectively disposed at outer sides of the first short sides of the optical through hole; and

the second coupling portion has second long sides and second short sides; the second long sides extend along the width direction of the fiber array; the second short sides are respectively perpendicular to the second long sides; there are two transverse grooves and two longitudinal grooves; the two transverse grooves are respectively disposed at outer sides of the second long sides of the second coupling portion; and the two longitudinal grooves are respectively disposed at outer sides of the second short sides of the second coupling portion.

Further, the transverse ribs are respectively spaced apart from the longitudinal ribs, and the transverse grooves respectively intersect with the longitudinal grooves.

Further, the transverse ribs and the longitudinal ribs each have an arc-shaped cross-sectional profile, and the transverse grooves and the longitudinal grooves each have a V-shaped cross-sectional profile.

Further, the pressing member is hinged to the top cover; a middle of the pressing member is provided with an elastic pressing sheet; the elastic pressing sheet protrudes toward the substrate; and the elastic pressing sheet and the pressing member are integrally formed.

Further, a side of the pressing member away from a hinged axis is further provided with a pressing portion; latch hooks are respectively disposed at two sides of the pressing portion in a width direction of the fiber array; the top cover is provided with a latch groove; the pressing portion is in an accommodating fit with the latch groove; an inner side of the latch groove is provided with a protruding edge; and the latch hooks are in a retaining fit with the protruding edge.

Further, the optical through hole includes a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

Further, the fixing structure includes an L-shaped block and a pressing plate; the L-shaped block includes a vertical segment and a horizontal segment that are fixedly connected; a middle of the horizontal segment is provided with a wiring groove; the pressing plate is parallel to and spaced apart from the vertical segment; the fiber array is disposed in the wiring groove and a gap between the pressing plate and the vertical segment; and the fiber array is bonded to the L-shaped block and the pressing plate.

The optical engine packaging structure based on grating coupling provided by the present disclosure has the following beneficial effects over the prior art: The optical engine packaging structure based on grating coupling includes the substrate, the silicon photonics chip, the fiber array unit, the top cover, and the pressing member. The silicon photonics chip is disposed at the top side of the substrate. The silicon photonics chip is electrically connected to the substrate. The top side of the silicon photonics chip is provided with the first coupling portion and the positioning seat. The optical through hole of the positioning seat corresponds to the first coupling portion. The top cover is disposed at the top side of the substrate. The top cover is provided with the insertion hole corresponding to the positioning seat. The fixing structure of the fiber array unit is detachably disposed in the insertion hole.

The top cover provides physical protection for the silicon photonics chip and the fiber array unit. By reasonably arranging the positioning seat, the optical through hole, and the fiber array unit, the optical engine packaging structure is more compact, reducing the size of an optical engine and meeting requirements for miniaturization and integration. Since the fiber array unit is detachably disposed, it can be removed from and disposed into the packaging structure when maintenance or upgrade of the optical engine or replacement of the fiber array unit is required, enhancing the maintainability and flexibility of the packaging structure.

The bottom side of the fixing structure is provided with the second coupling portion. The second coupling portion optically communicates with the fiber array. The top side of the positioning seat is provided with the first alignment structure, and the bottom side of the fixing structure is provided with the second alignment structure. Through the first coupling portion disposed on the silicon photonics chip and the second coupling portion of the fixing structure, and with the positioning fit between the first alignment structure of the positioning seat and the second alignment structure of the fixing structure within the radial plane of the optical through hole, the second coupling portion is in the vertical alignment with the first coupling portion.

The alignment design can realize high-precision optical coupling between the silicon photonics chip and the fiber array, enhancing the transmission efficiency of an optical signal, reducing the optical loss, and ensuring the high-performance operation of the optical engine. The optical through hole corresponds to the first coupling portion, and the second coupling portion optically communicates with the fiber array. This ensures that an optical signal transmission path between the first coupling portion and the second coupling portion is located within an enclosed space of the optical through hole, reducing the potential interference and loss of the optical signal.

Additionally, the top cover is further movably provided with the pressing member. The pressing member has the locked state and the unlocked state. In the locked state, the pressing member is in the pressing fit with the fixing structure along the axial direction of the optical through hole. In combination with the positioning fit between the first alignment structure and the second alignment structure within the radial plane of the optical through hole, precise multi-dimensional positioning of the fiber array unit can be realized. Locking the pressing member can prevent displacement or loosening of the fixing structure due to such factors as vibration and an external force, ensuring the stability and reliability of the optical coupling and meeting the requirements for coupling precision and flexible detachment of the fiber array unit.

### BRIEF DESCRIPTION OF THE DRAWINGS

FIG. 1 is a schematic perspective view of an optical engine packaging structure based on grating coupling according to an embodiment of the present disclosure;

FIG. 2 is a schematic assembly view of an electronic chip, a silicon photonics chip, a positioning seat, and a fiber array unit according to an embodiment of the present disclosure;

FIG. 3 is a schematic assembly view of an electronic chip, a silicon photonics chip, and a positioning seat according to an embodiment of the present disclosure;

FIG. 4 is a schematic perspective view of a fiber array unit (from another viewing angle) according to an embodiment of the present disclosure;

FIG. 5 is a partial enlarged view of a pressing member and a top cover in FIG. 1; and

FIG. 6 is a partial cross-sectional view of the optical engine packaging structure based on grating coupling in FIG. 1.

In the figures: 1: substrate, 2: silicon photonics chip, 21: first coupling portion, 22: positioning seat, 23: optical through hole, 231: first long side, 232: first short side, 233: first hole segment, 234: second hole segment, 24: first alignment structure, 24a: transverse rib, 24b: longitudinal rib, 3: fiber array unit, 31: fiber array, 32: fixing structure, 321: L-shaped block, 321a: vertical segment, 321b: horizontal segment, 321c: wiring groove, 322: pressing plate, 33: second alignment structure, 33a: transverse groove, 33b: longitudinal groove, 34: second coupling portion, 341: second long side, 342: second short side, 4: top cover, 40: insertion hole, 41: latch groove, 42: protruding edge, 5: pressing member, 50: hinged axis, 51: elastic pressing sheet, 52: pressing portion, 53: latch hook, 6: electronic chip, and 7: application-specific integrated circuit (ASIC) chip.

### DETAILED DESCRIPTION

The specific implementations of the present disclosure are described in more detail below with reference to the accompanying drawings and embodiments. The following embodiments are intended to illustrate the present disclosure, but not to limit the scope of the present disclosure.

It should be understood that, in the description of the present disclosure, the terms such as "central", ''longitudinal'', ''transverse'', ''long'', ''wide'', ''thick'', "upper", "lower", ''front'', ''back'', "left", "right", "vertical", "horizontal", ''top'', ''bottom'', "inner", "outer", ''clockwise'', and ''anticlockwise'' are intended to indicate orientation or position relationships shown in accompanying drawings, and these terms are merely intended to facilitate the description of the present disclosure or simplify the description, rather than to indicate or imply that the mentioned apparatus or elements must have the specific orientation or be constructed and operated in the specific orientation. Therefore, these terms may not be construed as a limitation to the present disclosure.

In addition, the terms "first" and "second" are merely intended for a purpose of description, and shall not be understood as an indication or implication of relative importance or implicit indication of a quantity of indicated technical features. Thus, features defined with "first" and "second" may explicitly or implicitly include one or more of the features. In the description of the present disclosure, "a plurality of" means two or more, unless otherwise specifically defined.

In the present disclosure, unless otherwise specified and defined, the terms such as "mounted", "connected to", "connected with", and "fixed" should be comprehended in a broad sense. For example, these terms may be comprehended as being fixedly connected, removably connected, or integrally connected; may be comprehended as being directly connected, or indirectly connected through an intermediate medium; and may be comprehended as being in an internal communication between two elements or an interactive relationship between two elements. Those of ordinary skill in the art may understand specific meanings of the above terms in the present disclosure based on a specific situation.

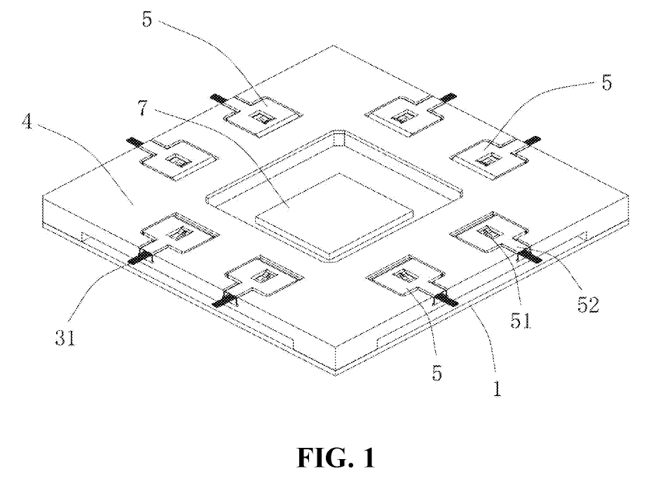

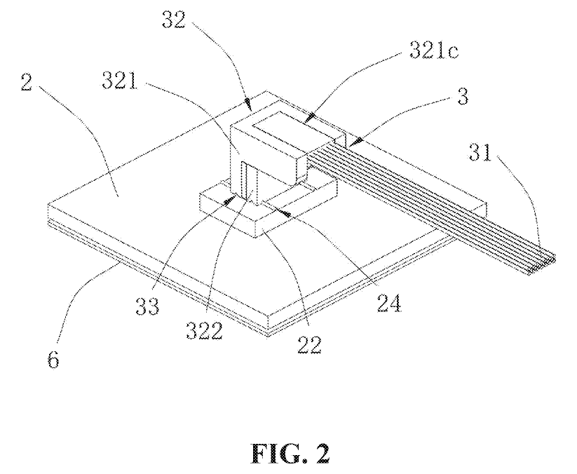

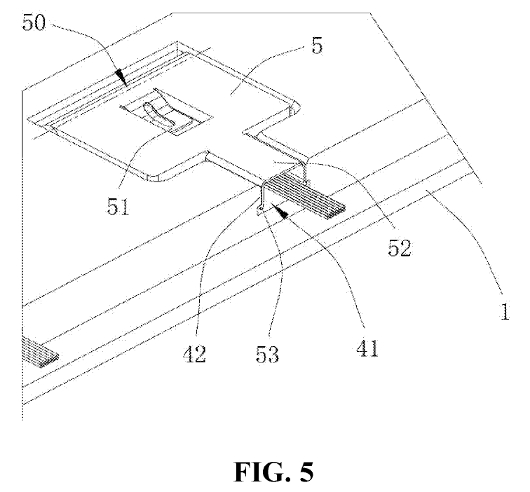

As shown in FIGS. 1-6, an embodiment of the present disclosure provides an optical engine packaging structure based on grating coupling. The optical engine packaging structure includes a substrate 1, a silicon photonics chip 2, a fiber array unit 3, and a top cover 4. The silicon photonics chip 2 is disposed at a top side of the substrate 1. The substrate 1 is electrically connected to the silicon photonics chip 2. A top side of the silicon photonics chip 2 is provided with a first coupling portion 21 and a positioning seat 22. The positioning seat 22 is provided with an optical through hole 23 that vertically penetrates through the positioning seat 22. The optical through hole 23 corresponds to the first coupling portion 21.

The fiber array unit 3 includes a fiber array 31 and a fixing structure 32. The fixing structure 32 is fixedly connected to the fiber array 31. A bottom side of the fixing structure 32 is provided with a second coupling portion 34. The second coupling portion 34 optically communicates with the fiber array 31. The top cover 4 is disposed at the top side of the substrate 1. The top cover 4 is provided with an insertion hole 40 corresponding to the positioning seat 22. The fixing structure 32 is detachably disposed in the insertion hole 40.

The top cover 4 is further movably provided with a pressing member 5. The pressing member 5 has a locked state and an unlocked state. In the locked state, the pressing member 5 is in a pressing fit with the fixing structure 32 along an axial direction of the optical through hole 23. The pressing fit means that there is a mutual acting force between the pressing member 5 and the fixing structure 32 along the axial direction of the optical through hole 23. A top side of the positioning seat 22 is provided with a first alignment structure 24. The bottom side of the fixing structure 32 is provided with a second alignment structure 33. The second alignment structure 33 is in a positioning fit with the first alignment structure 24 within a radial plane of the optical through hole 23. The positioning fit means that there is no relative displacement between the second alignment structure 33 and the first alignment structure 24 within the radial plane of the optical through hole 23. The second coupling portion 34 is in vertical alignment with the first coupling portion 21. The alignment means that geometric centers of the second coupling portion 34 and the first coupling portion 21 are located on a same vertically extending straight line.

The optical engine packaging structure based on grating coupling includes the substrate 1, the silicon photonics chip 2, the fiber array unit 3, the top cover 4, and the pressing member 5. The silicon photonics chip 2 is disposed at the top side of the substrate 1. The silicon photonics chip 2 is electrically connected to the substrate 1. The top side of the silicon photonics chip 2 is provided with the first coupling portion 21 and the positioning seat 22. The optical through hole 23 of the positioning seat 22 corresponds to the first coupling portion 21. The top cover 4 is disposed at the top side of the substrate 1. The top cover 4 is provided with the insertion hole 40 corresponding to the positioning seat 22. The fixing structure 32 of the fiber array unit 3 is detachably disposed in the insertion hole 40.

The top cover 4 provides physical protection for the silicon photonics chip 2 and the fiber array unit 3. By reasonably arranging the positioning seat 22, the optical through hole 23, and the fiber array unit 3, the optical engine packaging structure is more compact, reducing the size of an optical engine and meeting requirements for miniaturization and integration. Since the fiber array unit 3 is detachably disposed, it can be removed from and disposed into the packaging structure when maintenance or upgrade of the optical engine or replacement of the fiber array unit 3 is required, enhancing the maintainability and flexibility of the packaging structure.

The bottom side of the fixing structure 32 is provided with the second coupling portion 34. The second coupling portion 34 optically communicates with the fiber array 31. The top side of the positioning seat 22 is provided with the first alignment structure 24, and the bottom side of the fixing structure 32 is provided with the second alignment structure 33. Through the first coupling portion 21 disposed on the silicon photonics chip 2 and the second coupling portion 34 of the fixing structure 32, and with the positioning fit between the first alignment structure 24 of the positioning seat 22 and the second alignment structure 33 of the fixing structure 32 within the radial plane of the optical through hole 23, the second coupling portion 34 is in the vertical alignment with the first coupling portion 21.

The alignment design can realize high-precision optical coupling between the silicon photonics chip 2 and the fiber array 31, enhancing the transmission efficiency of an optical signal, reducing the optical loss, and ensuring the high-performance operation of the optical engine. The optical through hole 23 corresponds to the first coupling portion 21, and the second coupling portion 34 optically communicates with the fiber array 31. This ensures that an optical signal transmission path between the first coupling portion 21 and the second coupling portion 34 is located within an enclosed space of the optical through hole 23, reducing the potential interference and loss of the optical signal.

Additionally, the top cover 4 is movably provided with the pressing member 5. The pressing member 5 has the locked state and the unlocked state. In the locked state, the pressing member 5 is in the pressing fit with the fixing structure 32 along the axial direction of the optical through hole 23. In combination with the positioning fit between the first alignment structure 24 and the second alignment structure 33 within the radial plane of the optical through hole 23, precise multi-dimensional positioning of the fiber array unit can be realized. Locking the pressing member 5 can prevent displacement or loosening of the fixing structure 32 due to such factors as vibration and an external force, ensuring the stability and reliability of the optical coupling and meeting the requirements for coupling precision and flexible detachment of the fiber array unit 3.

In the embodiment, the first alignment structure 24 is a protrusion structure, and the second alignment structure 33 is a groove structure. Specifically, the first alignment structure 24 includes transverse ribs 24a and longitudinal ribs 24b. The transverse ribs 24a extend along a direction parallel to a width direction of the fiber array 31. The longitudinal ribs 24b are respectively perpendicular to the transverse ribs 24a within the radial plane of the optical through hole 23. The second alignment structure 33 includes transverse grooves 33a and longitudinal grooves 33b. The transverse grooves 33a extend along the direction parallel to the width direction of the fiber array 31. The longitudinal grooves 33b are respectively perpendicular to the transverse grooves 33a within the radial plane of the optical through hole 23. The transverse ribs 24a are respectively in a concave-convex fit with the transverse grooves 33a. The longitudinal ribs 24b are respectively in a concave-convex fit with the longitudinal grooves 33b.

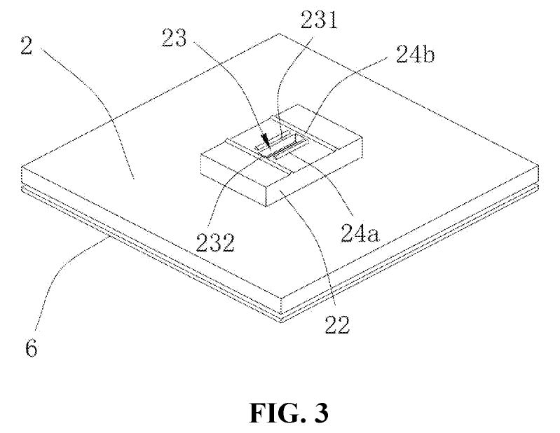

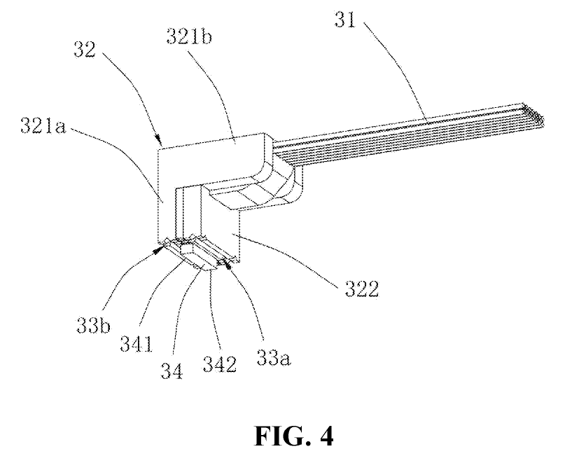

As shown in FIGS. 3, and 4, the optical through hole 23 has first long sides 231 and first short sides 232. The first long sides 231 extend along the width direction of the fiber array 31. The first short sides 232 are respectively perpendicular to the first long sides 231. There are two transverse ribs 24a and two longitudinal ribs 24b. The two transverse ribs 24a are respectively disposed at outer sides of the first long sides 231 of the optical through hole 23. The two longitudinal ribs 24b are respectively disposed at outer sides of the first short sides 232 of the optical through hole 23. The second coupling portion 34 has second long sides 341 and second short sides 342. The second long sides 341 extend along the width direction of the fiber array 31. The second short sides 342 are respectively perpendicular to the second long sides 341. There are two transverse grooves 33a and two longitudinal grooves 33b. The two transverse grooves 33aare respectively disposed at outer sides of the second long sides 341 of the second coupling portion 34. The two longitudinal grooves 33bare respectively disposed at outer sides of the second short sides 342 of the second coupling portion 34.

As a further preferred solution, the transverse ribs 24a are respectively spaced apart from the longitudinal ribs 24b, preventing potential interference on the positioning fit due to an overlapping portion between each transverse rib 24a and each longitudinal rib 24b. The transverse grooves 33a respectively intersect with the longitudinal grooves 33b. The transverse ribs 24a and the longitudinal ribs 24b each have an arc-shaped cross-sectional profile, and the transverse grooves 33aand the longitudinal grooves 33b each have a V-shaped cross-sectional profile. The fitted design between the arc-shaped rib and the V-shaped groove enables accurate positioning.

On the basis of the above embodiment, preferably, when the first alignment structure 24 is in the positioning fit with the second alignment structure 33, there may be a small gap between a top surface of the positioning seat 22 and a bottom surface of the fixing structure 32, i.e., there is no surface-to-surface contact between the positioning seat 22 and the fixing structure 32. The fixing structure 32 is positioned within a two-dimensional (2D) plane only through a fitted relationship between the transverse rib 24a and the transverse groove 33a, as well as between the longitudinal rib 24b and the longitudinal groove 33b. Specifically, the transverse rib 24a and the longitudinal rib 24b have a same height, ranging from 100 μm to 1,000 μm. The transverse groove 33aand the longitudinal groove 33b have a same depth. A difference between the depth of the transverse groove and the height of the longitudinal rib is not greater than ±500 μm. The small gap ranges from 20 μm to 500 μm.

In order to meet different use requirements, in other embodiments, the first alignment structure is a groove structure, and accordingly, the second alignment structure is a protrusion structure. By swapping concave and convex designs of the first alignment structure and the second alignment structure, the high-precision positioning between the first coupling portion and the second coupling portion within the radial plane of the optical through hole can also be achieved.

In the embodiment, the pressing member 5 is hinged to the top cover 4. A middle of the pressing member 5 is provided with an elastic pressing sheet 51. The elastic pressing sheet 51 protrudes the substrate 1. The elastic pressing sheet 51 and the pressing member 5 are integrally formed. The elastic pressing sheet 51 is a metal sheet. In the locked state, the elastic pressing sheet 51 can apply a stable elastic pressure to the fixing structure 32, thereby ensuring the coupling precision and reliability between the silicon photonics chip 2 and the fiber array 31.

As a further preferred solution, a side of the pressing member 5 away from a hinged axis 50 is further provided with a pressing portion 52. Latch hooks 53 are respectively disposed at two sides of the pressing portion 52 in a width direction of the fiber array 31. The top cover 4 is provided with a latch groove 41. The pressing portion 52 is in an accommodating fit with the latch groove 41, i.e., the latch groove 41 can allow the pressing portion 52 to enter, and a fit between the latch groove 41 and the pressing portion 52 is not limited to a clearance fit or an interference fit. An inner side of the latch groove 41 is provided with a protruding edge 42. The latch hooks 53 are in a retaining fit with the protruding edge 42, i.e., the protruding edge 42 retains or limits the latch hooks 53. The pressing portion 52 is pressed downward, until the pressing portion 52 is snap-fitted into the latch groove 41. The latch hooks 53 are in the retaining fit with the protruding edge 42 to ensure reliability of the snap-fit connection. In detachment, the pressing portion 52 is forced apart, such that the latch hooks 53 are disengaged from the protruding edge 42 to complete an unlocking operation. In this case, the pressing member 5 is in the unlocked state.

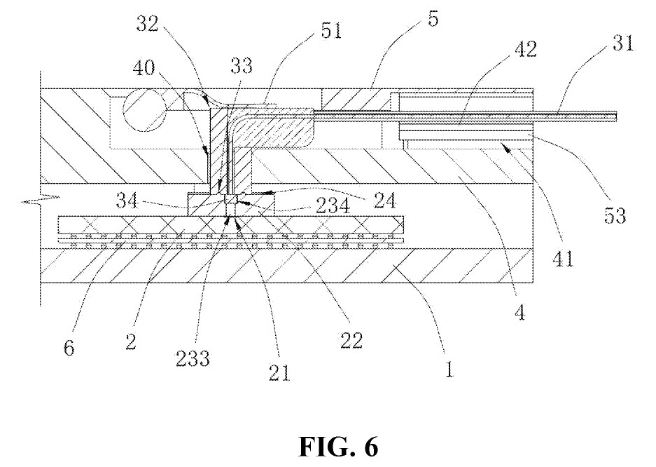

As shown in FIGS. 3, and 6, the optical through hole 23 includes a first hole segment 233 and a second hole segment 234 that are sequentially provided along the axial direction of the optical through hole 23. The second hole segment 234 is located on a side of the first hole segment 233 away from the silicon photonics chip 2. A cross-sectional width of the first hole segment 233 is less than a cross-sectional width of the second hole segment 234. The second coupling portion 34 is in an accommodating fit with the second hole segment 234. A width direction of the first hole segment 233 is perpendicular to the width direction of the fiber array 31 within the radial plane of the optical through hole 23. Through the positioning fit between the first alignment structure 24 and the second alignment structure 33, and the accommodating fit between the second coupling portion 34 and the second hole segment 234, a positioning function of a dual-fit structure is achieved, effectively improving positional accuracy of the second coupling portion 34. In the embodiment, the first coupling portion 21 is a microlens embedded into the silicon photonics chip 2. The microlens optically communicates with a waveguide, and is mainly configured to focus an optical signal and adjust a direction of the optical signal, so as to ensure transmission quality of the optical signal. Accordingly, the second coupling portion 34 is a lens, and is also configured to focus the optical signal and adjust the direction of the optical signal.

It is to be noted that the fixing structure 32 includes an L-shaped block 321 and a pressing plate 322. The L-shaped block 321 includes a vertical segment 321a and a horizontal segment 321b that are fixedly connected. A middle of the horizontal segment 321b is provided with a wiring groove 321c. The pressing plate 322 is parallel to and spaced apart from the vertical segment 321a. The fiber array 31 is disposed in the wiring groove 321c and a gap between the pressing plate 322 and the vertical segment 321a. The fiber array 31 is bonded to the L-shaped block 321 and the pressing plate 322, realizing a smooth change in a wiring direction of the fiber array 31. Additionally, the optical engine packaging structure further includes an electronic chip 6 and an ASIC chip 7. The electronic chip 6 and the ASIC chip 7 are flip-chip mounted on the top side of the substrate 1. The electronic chip 6 and the ASIC chip 7 are spaced apart. The silicon photonics chip 2 is flip-chip mounted on a top side of the electronic chip 6. The substrate 1 is electrically connected to the electronic chip 6 and the ASIC chip 7, thereby ensuring functions of optical/electrical signal processing and data computing.

The foregoing are merely the preferred implementation of the present disclosure. It should be noted that several improvements and replacements can be made by a person of ordinary skill in the art without departing from the technical principle of the present disclosure, and these improvements and replacements shall also be deemed as falling within the protection scope of the present disclosure.

1. An optical engine packaging structure based on grating coupling, comprising: a substrate, a silicon photonics chip, a fiber array unit, and a top cover, wherein the silicon photonics chip is disposed at a top side of the substrate; and the substrate is electrically connected to the silicon photonics chip;
a top side of the silicon photonics chip is provided with a first coupling portion and a positioning seat; the positioning seat is provided with an optical through hole that vertically penetrates through the positioning seat; and the optical through hole corresponds to the first coupling portion;
the fiber array unit comprises a fiber array and a fixing structure; the fixing structure is fixedly connected to the fiber array; a bottom side of the fixing structure is provided with a second coupling portion; and the second coupling portion optically communicates with the fiber array;
the top cover is disposed at the top side of the substrate; the top cover is provided with an insertion hole corresponding to the positioning seat; and the fixing structure is detachably disposed in the insertion hole;
the top cover is further movably provided with a pressing member; the pressing member has a locked state and an unlocked state; and in the locked state, the pressing member is in a pressing fit with the fixing structure along an axial direction of the optical through hole; and
a top side of the positioning seat is provided with a first alignment structure; the bottom side of the fixing structure is provided with a second alignment structure; the second alignment structure is in a positioning fit with the first alignment structure within a radial plane of the optical through hole; and the second coupling portion is in vertical alignment with the first coupling portion.

2. The optical engine packaging structure based on grating coupling according to claim 1, wherein the first alignment structure is a protrusion structure, and the second alignment structure is a groove structure.

3. The optical engine packaging structure based on grating coupling according to claim 1, wherein the first alignment structure is a groove structure, and the second alignment structure is a protrusion structure.

4. The optical engine packaging structure based on grating coupling according to claim 2, wherein the first alignment structure comprises transverse ribs and longitudinal ribs; the transverse ribs extend along a direction parallel to a width direction of the fiber array; and the longitudinal ribs are respectively perpendicular to the transverse ribs within the radial plane of the optical through hole;
the second alignment structure comprises transverse grooves and longitudinal grooves; the transverse grooves extend along the direction parallel to the width direction of the fiber array; and the longitudinal grooves are respectively perpendicular to the transverse grooves within the radial plane of the optical through hole; and
the transverse ribs are respectively in a concave-convex fit with the transverse grooves; and the longitudinal ribs are respectively in a concave-convex fit with the longitudinal grooves.

5. The optical engine packaging structure based on grating coupling according to claim 4, wherein the optical through hole has first long sides and first short sides; the first long sides extend along the width direction of the fiber array; the first short sides are respectively perpendicular to the first long sides; there are two transverse ribs and two longitudinal ribs; the two transverse ribs are respectively disposed at outer sides of the first long sides of the optical through hole; and the two longitudinal ribs are respectively disposed at outer sides of the first short sides of the optical through hole; and
the second coupling portion has second long sides and second short sides; the second long sides extend along the width direction of the fiber array; the second short sides are respectively perpendicular to the second long sides; there are two transverse grooves and two longitudinal grooves; the two transverse grooves are respectively disposed at outer sides of the second long sides of the second coupling portion; and the two longitudinal grooves are respectively disposed at outer sides of the second short sides of the second coupling portion.

6. The optical engine packaging structure based on grating coupling according to claim 4, wherein the transverse ribs are respectively spaced apart from the longitudinal ribs, and the transverse grooves respectively intersect with the longitudinal grooves.

7. The optical engine packaging structure based on grating coupling according to claim 5, wherein the transverse ribs are respectively spaced apart from the longitudinal ribs, and the transverse grooves respectively intersect with the longitudinal grooves.

8. The optical engine packaging structure based on grating coupling according to claim 4, wherein the transverse ribs and the longitudinal ribs each have an arc-shaped cross-sectional profile, and the transverse grooves and the longitudinal grooves each have a V-shaped cross-sectional profile.

9. The optical engine packaging structure based on grating coupling according to claim 5, wherein the transverse ribs and the longitudinal ribs each have an arc-shaped cross-sectional profile, and the transverse grooves and the longitudinal grooves each have a V-shaped cross-sectional profile.

10. The optical engine packaging structure based on grating coupling according to claim 1, wherein the pressing member is hinged to the top cover; a middle of the pressing member is provided with an elastic pressing sheet; the elastic pressing sheet protrudes toward the substrate; and the elastic pressing sheet and the pressing member are integrally formed.

11. The optical engine packaging structure based on grating coupling according to claim 10, wherein a side of the pressing member away from a hinged axis is further provided with a pressing portion; latch hooks are respectively disposed at two sides of the pressing portion in a width direction of the fiber array; the top cover is provided with a latch groove; the pressing portion is in an accommodating fit with the latch groove; an inner side of the latch groove is provided with a protruding edge; and the latch hooks are in a retaining fit with the protruding edge.

12. The optical engine packaging structure based on grating coupling according to claim 1, wherein the optical through hole comprises a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

13. The optical engine packaging structure based on grating coupling according to claim 2, wherein the optical through hole comprises a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

14. The optical engine packaging structure based on grating coupling according to claim 3, wherein the optical through hole comprises a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

15. The optical engine packaging structure based on grating coupling according to claim 4, wherein the optical through hole comprises a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

16. The optical engine packaging structure based on grating coupling according to claim 5, wherein the optical through hole comprises a first hole segment and a second hole segment that are sequentially provided along the axial direction of the optical through hole; the second hole segment is located on a side of the first hole segment away from the silicon photonics chip; a cross-sectional width of the first hole segment is less than a cross-sectional width of the second hole segment; and the second coupling portion is in an accommodating fit with the second hole segment.

17. The optical engine packaging structure based on grating coupling according to claim 1, wherein the fixing structure comprises an L-shaped block and a pressing plate; the L-shaped block comprises a vertical segment and a horizontal segment that are fixedly connected; a middle of the horizontal segment is provided with a wiring groove; the pressing plate is parallel to and spaced apart from the vertical segment; the fiber array is disposed in the wiring groove and a gap between the pressing plate and the vertical segment; and the fiber array is bonded to the L-shaped block and the pressing plate.

18. The optical engine packaging structure based on grating coupling according to claim 2, wherein the fixing structure comprises an L-shaped block and a pressing plate; the L-shaped block comprises a vertical segment and a horizontal segment that are fixedly connected; a middle of the horizontal segment is provided with a wiring groove; the pressing plate is parallel to and spaced apart from the vertical segment; the fiber array is disposed in the wiring groove and a gap between the pressing plate and the vertical segment; and the fiber array is bonded to the L-shaped block and the pressing plate.

19. The optical engine packaging structure based on grating coupling according to claim 4, wherein the fixing structure comprises an L-shaped block and a pressing plate; the L-shaped block comprises a vertical segment and a horizontal segment that are fixedly connected; a middle of the horizontal segment is provided with a wiring groove; the pressing plate is parallel to and spaced apart from the vertical segment; the fiber array is disposed in the wiring groove and a gap between the pressing plate and the vertical segment; and the fiber array is bonded to the L-shaped block and the pressing plate.

20. The optical engine packaging structure based on grating coupling according to claim 5, wherein the fixing structure comprises an L-shaped block and a pressing plate; the L-shaped block comprises a vertical segment and a horizontal segment that are fixedly connected; a middle of the horizontal segment is provided with a wiring groove; the pressing plate is parallel to and spaced apart from the vertical segment; the fiber array is disposed in the wiring groove and a gap between the pressing plate and the vertical segment; and the fiber array is bonded to the L-shaped block and the pressing plate.
